(19) United States
(12) Patent Application Publication
(10) Pub. No.: US 2005/0231093 A1
(43) Pub. Date: Oct. 20, 2005

(54) Method of reducing fluctuation in cut-off voltage, cathode for electron tube, and method for manufacturing cathode for electronic tube

(75) Inventors: Takao Sawada, Tokyo (JP); Shuhei Nakata, Tokyo (JP); Katsumi Oono, Tokyo (JP); Hiroshi Yamaguchi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/512,082

(22) PCT Filed: Jun. 19, 2002
(86) PCT No.: PCT/JP02/06127

§ 371 Date: Nov. 8, 2004

(51) Int. Cl. H01J 1/14; H01J 1/26

(52) U.S. Cl. 313/346 R

(57) ABSTRACT

A method of reducing a fluctuation in a cut-off voltage of a cathode for an electron tube in which a metal layer for protrusively deforming a cathode substrate when heated is formed on a surface of the cathode substrate, and an electron emissive material layer is formed on the front face of the cathode substrate directly or through the metal layer and a heater for heating the electron emissive material layer to emit a thermion from a front face of the electron emissive material layer is provided. When the front face of the electron emissive material layer is consumed and retreats, the protrusive deformation of the cathode substrate by the metal layer is induced by a heating operation of the heater so that the front face of the electron emissive material layer is correspondingly deformed protrusively.

### TECHNICAL FIELD

The present invention relates to an improvement in a cathode for an electron tube to be used in a cathode-ray tube.

### BACKGROUND ART

FIG. 8 is a schematic view showing a structure of a general cathode-ray tube. As shown in FIG. 8, generally, a cathode-ray tube 100 such as a television receiver comprises, as a main structure, a G1 electrode g and a cathode 103 for an electron tube provided behind the G1 electrode g at a constant distance D in a cathode-ray tube body 101.

The cathode 103 for an electron tube and the G1 electrode g constitute an electron gun. Usually, a current fetched from the cathode 103 for an electron tube is controlled by fixing a voltage to be applied to the G1 electrode g and transforming a voltage to be applied to the cathode 103 for an electron tube within 0 to a cut-off voltage. The cut-off voltage has a fixed value determined by the distance D between a front face 113a of the cathode 103 for an electron tube and the G1 electrode g.

Such a conventional cathode 103 for an electron tube to be used in the cathode-ray tube 100 has been described in Japanese Patent No. 2758244 and Japanese Patent Application Laid-Open No. 9-106750 (1997).

As shown in FIG. 9, these cathodes 103 for an electron tube comprise a heater 107 for indirect heating which is accommodated in a sleeve 105, a cathode substrate 109 provided on an opening at one end of the sleeve 105 and containing nickel to be a principal component and a reducing element such as magnesium or silicon, a metal layer 111 containing a reducing element such as tungsten as a principal component, and an electron emissive material layer 113 containing alkaline earth metal oxide including barium oxide to be a principal component and containing rare earth metal oxide such as scandium oxide.

The main parts 111 and 113 of the cathode 103 for an electron tube are manufactured in the following procedure.

\mathring{1} First of all, tungsten is adhered like a film to a front face 109a of the cathode substrate 109 provided in the cathode 103 for an electron tube to be a semifinished product, for example, and the adhered tungsten is heated in a hydrogen atmosphere and is fused onto the cathode substrate 109. Consequently, the metal layer 111 made of the tungsten is formed. \mathring{2} Next, a suspension consisting of carbonate of an alkaline earth metal such as barium and rare earth metal oxide is applied onto a front face 111a of the metal layer 111 and the applied suspension is heated to change the carbonate of the alkaline earth metal in the suspension into alkaline earth metal oxide. \mathring{3} Then, the alkaline earth metal oxide is heated and a part thereof is reduced to change the alkaline earth metal oxide into a semiconductor of an oxygen deficiency type which can easily emit a thermion. Consequently, the electron emissive material layer 113 is formed. In this way, the main parts 111 and 113 of the cathode 103 for an electron tube are manufactured.

In that case, in the \mathring{3}, a part of the alkaline earth metal oxide is reduced into a free alkaline earth metal by a reducing element contained in the cathode substrate 109 (magnesium (Mg)), silicon (Si)) or tungsten (W) contained in the metal layer 111. For example, a part of barium oxide (BaO) is reduced into free barium (Ba) by a reaction of formulas (1), (2) and (3). The free alkaline earth metal such as the free barium acts as a thermion emitting source.
2BaO+½Si=Ba+½Ba₂SiO₄ (1)
BaO+Mg=Ba+MgO (2)
2BaO+⅓W=Ba+⅓Ba₃WO₆ (3)

In the \mathring{3}, moreover, the rare earth metal oxide contained in the electron emissive material layer 113 is reduced into a rare earth metal by the tungsten contained in the metal layer 111. Barium silicate (Ba₂SiO₄), magnesium oxide (MgO) and barium tungstate (Ba₃WO₆) which are by-products generated by the reaction of the formulas (1), (2) and (3) and are referred to as so-called intermediate layers are decomposed by the rare earth metal. By the decomposition, the free alkaline earth metal is smoothly generated.

In the cathode 103 for an electron tube, the electron emissive material layer 113 is heated by the heater 107 for indirect heating so that a thermion is emitted from the front face 113a of the electron emissive material layer 113 and is supplied to a fetch current. In particular, the metal layer 111 comprising a reducing element is formed between the cathode substrate 109 and the electron emissive material layer 113 so that an amount of generation of the free alkaline earth metal to be the thermion emitting source is increased, resulting in an increase in a current fetched from the cathode 103 for an electron tube.

Moreover, another example of the conventional cathode 103 for an electron tube has been described in Japanese Patent Application Laid-Open No. 54-83360 (1979).

The cathode for an electron tube is constituted by a cathode substrate, an electron emissive material layer formed on a front face of the cathode substrate, comprising alkaline earth metal oxide containing barium oxide and a content of the barium oxide which is more reduced on a contact face side with the cathode substrate than the front face side, and a heater for indirect heating which heats the electron emissive material layer.

In the cathode for an electron tube, the content of the barium oxide in the electron emissive material is set to be lower on the contact face side with the cathode substrate than the front face side so that a current fetched from the cathode for an electron tube is increased.

In the cathode-ray tube 100 using the conventional cathode 103 for an electron tube, however, there is a problem in that a fluctuation in a cut-off voltage causing a change in a color purity is remarkable in an operating environment in which the current fetched from the cathode 109 for an electron tube exceeds 4 A/cm², for example.

The problem is caused by the fact that the fetch current is increased, resulting in remarkable consumption (evaporation) of a surface of the front face 113a of the electron emissive material layer 113 and an increase in the distance D between the front face 113a of the electron emissive material layer 113 and the G1 electrode g (which has been known in Kenkyukai Siryo of the Illuminating Engineering Institute of Japan (MD-95-12)). In general, the following two mechanisms for the consumption of the electron emissive material layer 113 can be supposed. \mathring{1} First of all, the consumption is caused by evaporation (pure thermal evaporation) of the electron emissive material layer 113 at a vapor pressure generated on the electron emissive material layer 113 with a heating operation of the heater 107 for indirect heating (for example, approximately 700 to 800° C.), and is proportional to a heating temperature of the heater 107 for indirect heating and can be disregarded at the heating temperature of the heater 107 for indirect heating during an operation of the cathode-ray tube 100. \mathring{2} Secondly, the consumption is caused by evaporation of free barium in the electron emissive material layer 113 with emission of a thermion from the electron emissive material layer 113, and can be disregarded if a fetch current is small and cannot be disregarded if the fetch current is increased. It can be supposed that the consumption of the electron emissive material layer 113 becomes remarkable because of the mechanism in the latter \mathring{2} when the fetch current is increased.

In the conventional cathode for an electron tube, thus, there is a problem in that a fluctuation in a cut-off voltage in the operation of the cathode-ray tube becomes remarkable if the current fetched from the cathode for an electron tube is increased.

### DISCLOSURE OF THE INVENTION

It is an object of the present invention to solve the above-mentioned problems and to provide a method of reducing a fluctuation in a cut-off voltage which can reduce a fluctuation in a cut-off voltage in an operation of a cathode-ray tube, a cathode for an electron tube and a method of manufacturing the cathode for an electron tube.

The present inventor found that a cut-off voltage fluctuates because a front face of an electron emissive material layer is consumed and retreats, resulting in an increase in a distance D between the front face of the electron emissive material layer and a G1 electrode g, and completed the present invention.

More specifically, a first aspect of the present invention is directed to a method of reducing a fluctuation in a cut-off voltage of a cathode for an electron tube in which a metal layer for protrusively deforming a cathode substrate when heated is formed on a surface of the cathode substrate, and an electron emissive material layer is formed on a front face of the cathode substrate directly or through the metal layer and heating means for heating the electron emissive material layer to emit a thermion from a front face of the electron emissive material layer is provided, wherein when the front face of the electron emissive material layer is consumed and retreats, the protrusive deformation of the cathode substrate by the metal layer is induced by a heating operation of the heating means so that the front face of the electron emissive material layer is correspondingly deformed protrusively.

According to this aspect, when the front face of the electron emissive material layer is consumed and retreats, the protrusive deformation of the cathode substrate by the metal layer is induced by the heating operation of the heating means so that the front face of the electron emissive material layer is correspondingly deformed protrusively. Even if the front face of the electron emissive material layer is consumed, therefore, the position of the front face of the electron emissive material layer can be maintained to be almost constant and the fluctuation in the cut-off voltage in an operation of a cathode-ray tube can be reduced.

A second aspect of the present invention is directed to the method of reducing a fluctuation in a cut-off voltage, wherein the metal layer is formed on the front face of the cathode substrate and is alloyed with a metal contained in the cathode substrate by the heating operation of the heating means and is thus expanded, thereby protrusively deforming the front face of the cathode substrate.

According to this aspect, the cathode substrate is deformed protrusively by utilizing the expansion generated with the alloying of the metal layer and the cathode substrate. Consequently, the cathode substrate can be deformed protrusively by a simple method.

A third aspect of the present invention is directed to the method of reducing a fluctuation in a cut-off voltage, wherein the metal layer is formed on concavo-convex portions provided on the surface of the cathode substrate.

According to this aspect, a contact area of the cathode substrate with the metal layer is increased by the concavo-convex portions formed on the front face of the cathode substrate. Therefore, it is possible to cause the protrusion and deformation of the cathode substrate in a sufficient amount with a small formation area (an area seen on a plane).

A fourth aspect of the present invention is directed to the method of reducing a fluctuation in a cut-off voltage, wherein the metal layer is divided into a plurality of parts which are dispersively formed on the surface of the cathode substrate.

According to this aspect, the metal layer is divided into a plurality of parts which are dispersively formed on the surface of the cathode substrate. Therefore, it is easy to optimize the protrusion and deformation of the cathode substrate by the expansion generated with the alloying of the metal layer and the cathode substrate.

Moreover, a first aspect of the present invention is directed to a cathode for an electron tube comprising a cathode substrate, a metal layer formed on a surface of the cathode substrate and heated to protrusively deform the cathode substrate, an electron emissive material layer formed on a front face of the cathode substrate directly or through the metal layer, and heating means for heating the electron emissive material layer to emit a thermion from a front face of the electron emissive material layer, wherein when the front face of the electron emissive material layer is consumed and retreats, the protrusive deformation of the cathode substrate by the metal layer is induced by a heating operation of the heating means so that the front face of the electron emissive material layer is correspondingly deformed protrusively.

According to this aspect, when the front face of the electron emissive material layer is consumed and retreats, the protrusive deformation of the cathode substrate by the metal layer is induced by the heating operation of the heating means so that the front face of the electron emissive material layer is correspondingly deformed protrusively. Even if the front face of the electron emissive material layer is consumed, therefore, the position of the front face of the electron emissive material layer can be maintained to be almost constant and the fluctuation in the cut-off voltage in an operation of a cathode-ray tube can be reduced.

A second aspect of the present invention is directed to the cathode for an electron tube, wherein the metal layer is formed on the front face of the cathode substrate and is alloyed with a metal contained in the cathode substrate by the heating operation of the heating means and is thus expanded, thereby protrusively deforming the front face of the cathode substrate.

According to this aspect, the cathode substrate is deformed protrusively by utilizing the expansion generated with the alloying of the metal layer and the cathode substrate. Therefore, the cathode substrate can be deformed protrusively by a simple method.

A third aspect of the present invention is directed to the cathode for an electron tube, wherein the metal layer is formed on concavo-convex portions provided on the surface of the cathode substrate.

According to this aspect, a contact area of the cathode substrate with the metal layer is increased by the concavo-convex portions formed on the front face of the cathode substrate. Therefore, it is possible to cause the protrusion and deformation of the cathode substrate in a sufficient amount with a small formation area (an area seen on a plane).

A fourth aspect of the present invention is directed to the cathode for an electron tube, wherein the metal layer is divided into a plurality of parts which are dispersively formed on the surface of the cathode substrate.

According to this aspect, the metal layer is divided into a plurality of parts which are dispersively formed on the surface of the cathode substrate. Therefore, it is easy to optimize the protrusion and deformation of the cathode substrate by the expansion generated with the alloying of the metal layer and the cathode substrate.

Moreover, a first aspect of the present invention is directed to a method of manufacturing a cathode for an electron tube, comprising the steps of (a) forming, on a surface of a cathode substrate, a metal layer for protrusively deforming the cathode substrate when heated, (b) forming an electron emissive material layer on a front face of the cathode substrate directly or through the metal layer, and (c) providing heating means for heating the electron emissive material layer to emit a thermion from a front face of the electron emissive material layer, wherein at the step (a), the metal layer is formed in such a manner that when the front face of the electron emissive material layer is consumed and retreats, the protrusive deformation of the cathode substrate by the metal layer is induced by a heating operation of the heating means and the front face of the electron emissive material layer is correspondingly deformed protrusively.

According to this aspect, the metal layer is formed in such a manner that when the front face of the electron emissive material layer is consumed and retreats, the protrusive deformation of the cathode substrate by the metal layer is induced by the heating operation of the heating means and the front face of the electron emissive material layer is correspondingly deformed protrusively. Therefore, it is possible to manufacture the cathode for an electron tube which can maintain the position of the front face of the electron emissive material layer to be almost constant and can reduce the fluctuation in the cut-off voltage in an operation of a cathode-ray tube even if the front face of the electron emissive material layer is consumed.

A second aspect of the present invention is directed to the method of manufacturing a cathode for an electron tube, wherein at the step (a), the metal layer is formed on the front face of the cathode substrate by a metal which is alloyed with a metal contained in the cathode substrate by a heating operation of the heating means and is thus expanded, thereby protrusively deforming the front face of the cathode substrate.

According to this aspect, the metal layer is formed on the front face of the cathode substrate by a metal which is alloyed with a metal contained in the cathode substrate by a heating operation of the heating means and is thus expanded, thereby protrusively deforming the front face of the cathode substrate. Therefore, it is possible to manufacture the cathode for an electron tube which can forward protrude and deform the cathode substrate by a simple method.

A third aspect of the present invention is directed to the method of manufacturing a cathode for an electron tube, wherein at the step (a), concavo-convex portions are formed on the surface of the cathode substrate and the metal layer is formed on the concavo-convex portions.

According to this aspect, the concavo-convex portions are formed on the surface of the cathode substrate and the metal layer is formed on the concavo-convex portions. Therefore, it is possible to manufacture the cathode for an electron tube in which a contact area of the cathode substrate with the metal layer is increased and the protrusion and deformation of the cathode substrate can be caused in a sufficient amount with a small formation area (an area seen on a plane).

A fourth aspect of the present invention is directed to the method of manufacturing a cathode for an electron tube, wherein at the step (a), the metal layer is divided into a plurality of parts which are dispersively formed on the surface of the cathode substrate.

According to this aspect, the metal layer is divided into a plurality of parts which are dispersively formed on the surface of the cathode substrate. Therefore, it is possible to manufacture the cathode for an electron tube which can easily optimize the protrusion and deformation of the cathode substrate by the expansion generated with the alloying of the metal layer and the cathode substrate.

Objects, features, aspects and advantages of the present invention will be more apparent from the following detailed description and the accompanying drawings.

### BRIEF DESCRIPTION OF THE DRAWINGS

FIG. 1 is a view showing a structure of a main part obtained before protrusive deformation of a cathode for an electron tube and a G1 electrode according to an embodiment of the present invention.

FIG. 2 is a view showing the structure of the main part obtained after the protrusive deformation of the cathode for an electron tube and the G1 electrode according to the embodiment of the present invention.

FIG. 3 is a chart showing a relationship between an amount of a decrease in a thickness P of an electron emissive material layer and amount Q of protrusive deformation of a cathode substrate.

FIG. 4 is a chart showing a comparison of a result of a test for a temporal fluctuation of a fetch current of the cathode for an electron tube according to the embodiment of the present invention with a result of a test for a temporal fluctuation in a fetch current of a cathode for an electron tube according to a comparative example.

FIG. 5 is a chart showing a comparison of a result of a test for a temporal fluctuation in a cut-off voltage in the case in which the cathode for an electron tube according to the embodiment of the present invention is used with a result of a test for a temporal fluctuation in a cut-off voltage in the case in which a cathode for an electron tube according to a comparative example is used.

FIG. 6 is a sectional view showing a real thing of the cathode substrate of the cathode for an electron tube according to the embodiment after the test of FIG. 5.

FIG. 7 is a sectional view showing the real thing of a cathode substrate of the cathode for an electron tube according to the comparative example after the test of FIG. 5.

FIG. 8 is a schematic view showing a structure of a general cathode-ray tube.

FIG. 9 is a view showing an example of a schematic structure of a conventional cathode for an electron tube.

### BEST MODE FOR CARRYING OUT THE INVENTION

### 1. Embodiment

A fluctuation in a cut-off voltage of a cathode for an electron tube causes a change in a luminance and a difference in a color in a CRT, for example. This is a phenomenon which is presented because a drive curve is shifted and a fetch current is changed by the fluctuation in the cut-off voltage so that a current ratio between electron guns of RGB is varied and a luminance and a white balance are thus lost. The present invention provides a technique for suppressing a fluctuation in a distance between a cathode for an electron tube and a G1 electrode which is the most important cause of the phenomenon, thereby controlling a fluctuation in a cut-off voltage. More specifically, the present invention provides a technique for suppressing a fluctuation in a cut-off voltage by protrusively deforming a front face of an electron emissive material layer like a convex to maintain the distance between the cathode for an electron tube and the G1 electrode which is caused by consumption (evaporation) and retreat of the front face of the electron emissive material layer (an electrode emitting surface) constituting the cathode for an electron tube in a lifetime to be constant. An embodiment of the present invention will be described below.

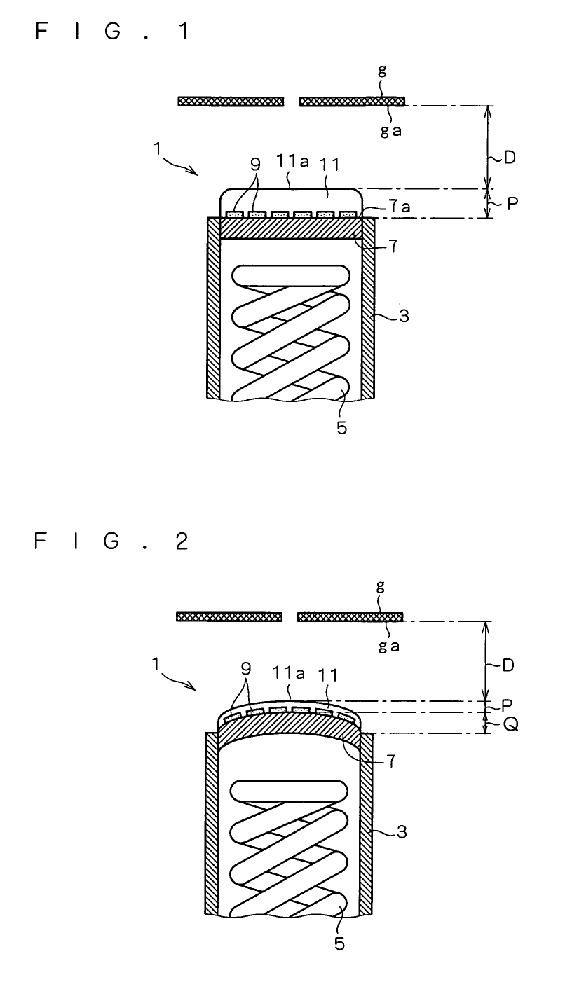

As shown in FIG. 1, a cathode 1 for an electron tube according to the present embodiment comprises a cylindrical sleeve 3, a heater 5 for indirect heating which is accommodated in the sleeve 3, a cathode substrate 7 provided on an opening at one end of the sleeve 3, a metal layer 9 formed on a surface (a front face) 7a of the cathode substrate 7, and an electron emissive material layer 11 formed on the front face 7a of the cathode substrate 7 directly or through the metal layer 9, for example.

The cathode substrate 7 is formed like a flat plate, for example, and concavo-convex portions having proper sizes (not shown) are formed on the front face 7a. The cathode substrate 7 contains nickel as a principal component, for example, and contains, as a reducing agent, at least one kind of reducing element such as silicon or magnesium.

The metal layer 9 is constituted by \mathring{1} a metal having such a property as to be expanded by alloying with at least a metal (nickel) contained in the cathode substrate 7 and \mathring{2} a metal having a reducing property. For the metals to satisfy the conditions \mathring{1} and \mathring{2}, at least one of tungsten, molybdenum, chromium, zirconium, cobalt and aluminum is used, for example. Moreover, the metal layer 9 is divided and dispersed into a plurality of parts and to have a formation area having a proper size (an area seen on a plane) on the concavo-convex portions formed on the front face 7a of the cathode substrate 7, for example, and is formed like a film having a proper thickness.

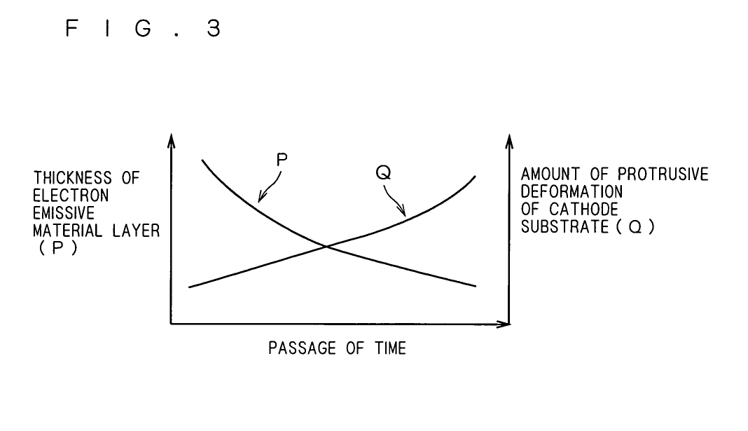

By such a formation, as shown in FIGS. 2 and 3, the metal layer 9 is alloyed with the cathode substrate 7 by a heating operation of the heater 5 for indirect heating in an operation of a cathode-ray tube and is thus expanded properly in a direction of a surface of the cathode substrate 7, and the cathode substrate 7 is protrusively deformed (curved like a convex) by the expansion so that a front face 11a of the electron emissive material layer 11 is consumed (evaporated) to retreat. Correspondingly, the front face 11a of the electron emissive material layer 11 is protrusively deformed (curved like a convex). More specifically, an amount of the retreat caused by the consumption of the front face 11a of the electron emissive material layer 11, that is, an amount of a decrease in a thickness P of the electron emissive material layer 11 is compensated by an amount Q of the protrusive deformation of the cathode substrate 7 (that is, the amount Q of the protrusive deformation of the front face 11a of the electron emissive material layer 11).

The electron emissive material layer 11 contains, as a principal component, alkaline earth metal oxide containing at least barium oxide, and desirably, 0.01 to 25% by weight of rare earth metal oxide such as scandium oxide.

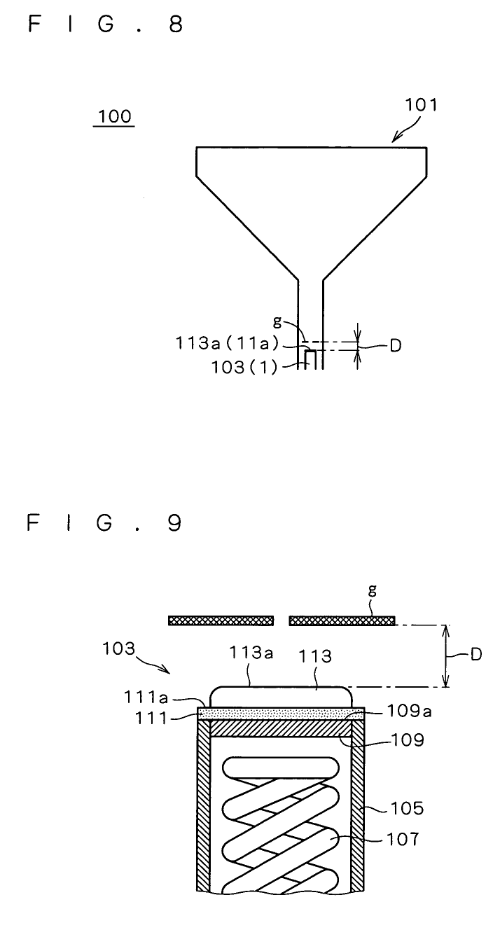

In the same manner as in the conventional art, the cathode 1 for an electron tube is positioned behind a G1 electrode g by a constant distance D and is thus accommodated in a cathode-ray tube 100 as shown in FIG. 8. The distance D represents a distance between a rear face ga of the G1 electrode g and the front face 11a of the electron emissive material layer 11.

Next, a method of manufacturing the main parts 9 and 11 of the cathode 1 for an electron tube will be described with reference to FIG. 1.

First of all, the semifinished cathode 1 for an electron tube comprising the cathode substrate 7 containing nickel as a principal component and magnesium as a reducing agent, for example, is prepared. Concavo-convex portions are formed on the front face 7a of the cathode substrate 7 by a sand blasting method, for example. In the sand blasting method, an abrasive is mixed with air, water or the like and the mixture is sprayed onto a member, thereby forming very small concavo-convex portions on a surface of the member. While various materials can be used for the abrasive in that case, calcium carbonate having a comparatively small hardness is used in consideration of the fact that the principal component of the cathode substrate 7 is nickel to be a soft material, for example.

For example, calcium carbonate having a particle size of No. 600 is mixed as an abrasive with air having an air pressure of 0.05 to 0.1 Mpa, for example, and the mixture is sprayed onto only the front face 7a of the cathode substrate 7 for 5 to 10 minutes to form concavo-convex portions having an irregularity of ±10 to 20 μm (a maximum height (Ry) defined by JISB0601 is 20 μm) on the front face 7a of the cathode substrate 7, for example.

Next, the metal layer 9 comprising tungsten is formed on the concavo-convex portions provided on the front face 7a of the cathode substrate 7, for example. More specifically, \mathring{1} first of all, the tungsten is deposited like a film having a thickness of 1 μm on the concavo-convex portions formed on the front face 7a of the cathode substrate 7 by a sputtering method, for example. \mathring{2} In that case, the front face 7a of the cathode substrate 7 is partially covered with a mask, thereby dividing, dispersing and depositing the tungsten into a plurality of parts to have a proper deposition area. \mathring{3} Then, a heat treatment is carried out at 800 to 1000° C. in a hydrogen atmosphere to fuse the tungsten onto the cathode substrate 7, for example. Consequently, the metal layer 9 comprising the tungsten is formed, for example.

In that case, in the \mathring{2}, the deposition area of the tungsten (that is, the formation area of the metal layer 9), a dividing method and a dispersing way are regulated in such a manner that the amount Q of the protrusive deformation of the cathode substrate 7 generated by an expansion with alloying of the metal layer 9 and the cathode substrate 7 which is induced by the heating operation of the heater 5 for indirect heating in the operation of the cathode-ray tube (that is, the amount Q of the protrusive deformation of the front face 11a of the electron emissive material layer 11) and the amount of the retreat carried out by the consumption of the front face 11a of the electron emissive material layer 11, that is, the amount of a decrease in the thickness P of the electron emissive material layer 11 are set to be almost equal to each other as shown in FIGS. 2 and 3.

The regulation cannot be defined by an area ratio or the like but is determined after trial and error by an experiment because the amount of the protrusive deformation of the cathode substrate 7 is changed depending on the type (property) of a metal to be used for the metal layer 9, the thickness of the metal layer 9 and the sizes of the concavo-convex portions formed on the front face 7a of the cathode substrate 7.

In the heat treatment of the \mathring{3}, moreover, the metal layer 9 and the cathode substrate 7 are prevented from being alloyed completely by the heat treatment. The reason is that it is necessary to alloy the metal layer 9 with the cathode substrate 7 by the heating operation of the heater 5 for indirect heating in the operation of the cathode-ray tube in the present invention.

Next, the electron emissive material layer 11 is formed on the front face 7a of the cathode substrate 7 through the metal layer 9. More specifically, first of all, ternary carbonate of an alkaline earth metal containing barium, strontium and calcium, 3% by weight of scandium oxide, for example, and a binder and a solvent are mixed to prepare a suspension. The suspension thus prepared is applied in a thickness of approximately 80 μm onto the front face 7a of the cathode substrate 7 through the metal layer 9 by a spray method, for example.

The cathode 1 for an electron tube to be a semifinished product in the manufacturing stage is incorporated in the electron guns of the cathode-ray tube and the suspension applied onto the front face 7a of the cathode substrate 7 is heated by the heater 5 for indirect heating provided in the cathode 1 for an electron tube to be the semifinished product at an evacuating step in the process for manufacturing the cathode-ray tube. Consequently, the carbonate of the alkaline earth metal in the applied suspension is changed into alkaline earth metal oxide, and furthermore, a part thereof is reduced and changed into a free alkaline earth metal to be a thermion emitting source. Thus, the carbonate of the alkaline earth metal in the suspension is changed into an oxygen deficiency type semiconductor which can easily emit a thermion. Consequently, the electron emissive material layer 11 is formed. In that case, a by-product referred to as a so-called intermediate layer generated by the reducing reaction is decomposed by a rare earth metal reduced and generated from the rare earth metal oxide contained in the suspension. Consequently, the free alkaline earth metal is smoothly generated without an interference of the by-product. As described above, the main parts 7 and 11 of the cathode 1 for an electron tube are manufactured.

According to the cathode 1 for an electron tube which is constituted as described above, (A) the electron emissive material layer 11 contains the rare earth metal oxide, (B) the metal layer 9 comprising a reducing element is provided between the cathode substrate 7 and the electron emissive material layer 11, and (C) the concavo-convex portions are formed on the front face 7a of the cathode substrate 7 and the electron emissive material layer 11 is formed on the concavo-convex portions through the metal layer 9. Therefore, it is possible to obtain a large fetch current having a magnitude of 4 A/cm² on an average.

In this case, by the technique of the (A), a by-product referred to as a so-called intermediate layer generated in the process for forming the electron emissive material layer 11 is decomposed by a rare earth metal generated by reducing the contained rare earth metal oxide. Consequently, a free alkaline earth metal to be a thermion emitting source can be generated smoothly. Thus, it is possible to reduce an attenuation of a fetch current.

By the technique of the (B), moreover, the reducing reaction from the rare earth metal oxide to the rare earth metal based on the technique of the (A) is promoted. Therefore, the attenuation of the fetch current can further be reduced. In addition, the reducing reaction occurring in the process for generating the electron emissive material layer 11 is promoted. Consequently, the generation of the free alkaline earth metal to be the thermion emitting source can be promoted. Thus, the fetch current can be increased.

By the technique of the (C), furthermore, an adhesion between the cathode substrate 7, the metal layer 9 and the electron emissive material layer 11 can be enhanced and a contact area can be increased. Consequently, \mathring{1} the reducing reaction occurring in the process for forming the electron emissive material layer 11 is further promoted. Therefore, an amount of the generation of the free alkaline earth metal to be the thermion emitting source can further be increased. Consequently, the fetch current can further be increased. \mathring{2} The reducing reaction from the rare earth metal oxide to the rare earth metal by the technique of the (A) is further promoted. Consequently, the attenuation of the fetch current can further be reduced.

In the cathode for an electron tube which is constituted in the same manner except that the techniques of the (A) to (C) are not carried out, a fetch current has a magnitude of approximately 0.5 A/cm². In the cathode for an electron tube which is further subjected to the technique of the (A), a fetch current has a magnitude of approximately 2.0 A/cm². In the cathode for an electron tube which is further subjected to the technique of the (B), a fetch current has a magnitude of approximately 3.0 A/cm². In the cathode for an electron tube which is further subjected to the technique of the (C) (the cathode 1 for an electron tube according to the present embodiment), a fetch current has a magnitude of approximately 4.0 A/cm². As a result, it is apparent that the fetch current can further be increased as described above by the technique of the (C).

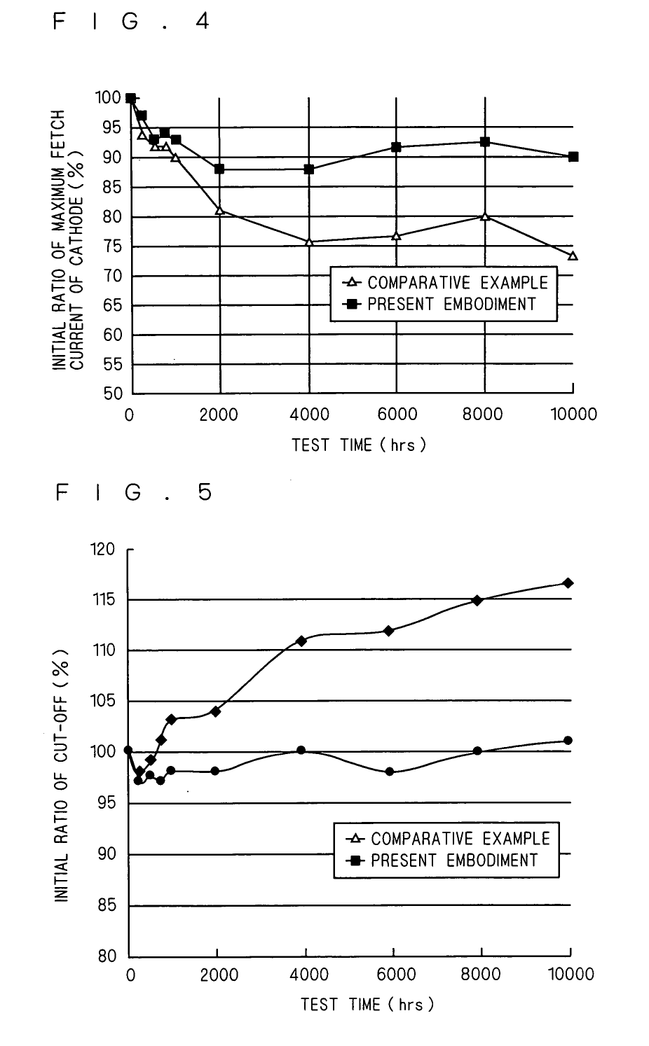

FIG. 4 is a chart showing a comparison between a result of a test for a temporal fluctuation in a maximum fetch current of the cathode 1 for an electron tube according to the present embodiment and a result of a test for a temporal fluctuation of a maximum fetch current of a cathode for an electron tube according to a comparative example. In FIG. 4, an axis of ordinate indicates a relative value obtained by setting an initial value of the maximum fetch current to be 100 (an initial ratio of the maximum fetch current of the cathode). The cathode for an electron tube according to the comparative example has the same structure as that of the cathode 1 for an electron tube according to the present embodiment except that the technique of the (C) is not carried out. From the result of FIG. 4, it is apparent that the attenuation of the fetch current is more reduced in the cathode 1 for an electron tube according to the present embodiment than that in the cathode for an electron tube according to the comparative example. From this result, it is apparent that the attenuation of the fetch current can further be reduced as described above by the technique of the (C).

According to the cathode 1 for an electron tube which is constituted as described above, furthermore, (D) the metal layer 9 is alloyed with the cathode substrate 7 by the heating operation of the heater 5 for indirect heating in the operation of the cathode-ray tube and is properly expanded in the direction of the surface of the cathode substrate 7, and the cathode substrate 7 is deformed protrusively by the expansion so that the front face 11a of the electron emissive material layer 11 is consumed and retreats. Correspondingly, the metal layer 9 is formed in such a manner that the front face 11a of the electron emissive material layer 11 is deformed protrusively. Even if the front face 11a of the electron emissive material layer 11 is consumed, therefore, the position of the front face 11a of the electron emissive material layer 11 can be maintained to be almost constant. In other words, it is possible to reduce a fluctuation in the distance D between the front face 11a of the electron emissive material layer 11 and the G1 electrode g. Consequently, it is possible to reduce a fluctuation in a cut-off voltage in the operation of the cathode-ray tube. The effect is concluded from results of tests shown in FIGS. 5 to 7 which will be described below.

In this case, the cathode substrate 7 is deformed protrusively by utilizing the expansion with the alloying of the metal layer 9 and the cathode substrate 7. Therefore, the cathode substrate 7 can be deformed protrusively by a simple method.

Moreover, the metal layer 9 is divided into a plurality of parts with a proper formation area which are dispersively formed. Therefore, it is easy to optimize the protrusion and deformation of the cathode substrate 7 by the expansion with the alloying of the metal layer 9 and the cathode substrate 7.

Furthermore, a contact area of the cathode substrate 7 with the metal layer 9 is increased by the concavo-convex portions formed on the front face 7a of the cathode substrate 7. Consequently, the cathode substrate 7 can be protruded and deformed in a sufficient amount with a small formation area (an area seen on a plane).

FIG. 5 is a chart showing a comparison between a result of a test for a temporal fluctuation of a cut-off voltage in the case in which the cathode 1 for an electron tube according to the embodiment of the present invention is used and a result of a test for a temporal fluctuation in a cut-off voltage in which a cathode for an electron tube according to a comparative example is used. In FIG. 5, an axis of ordinate indicates a relative value by setting an initial value of the cut-off voltage (a cut-off initial ratio) to be 100. Both fetch currents have a magnitude of 4 A/cm². The cathode for an electron tube according to the comparative example has the same structure as that of the cathode 1 for an electron tube according to the present embodiment except that the technique of the (D) is not carried out. From the result of FIG. 5, it is apparent that the cathode 1 for an electron tube according to the present embodiment has the fluctuation in the cut-off voltage in the operation of the cathode-ray tube which is more reduced than that in the cathode for an electron tube according to the comparative example.

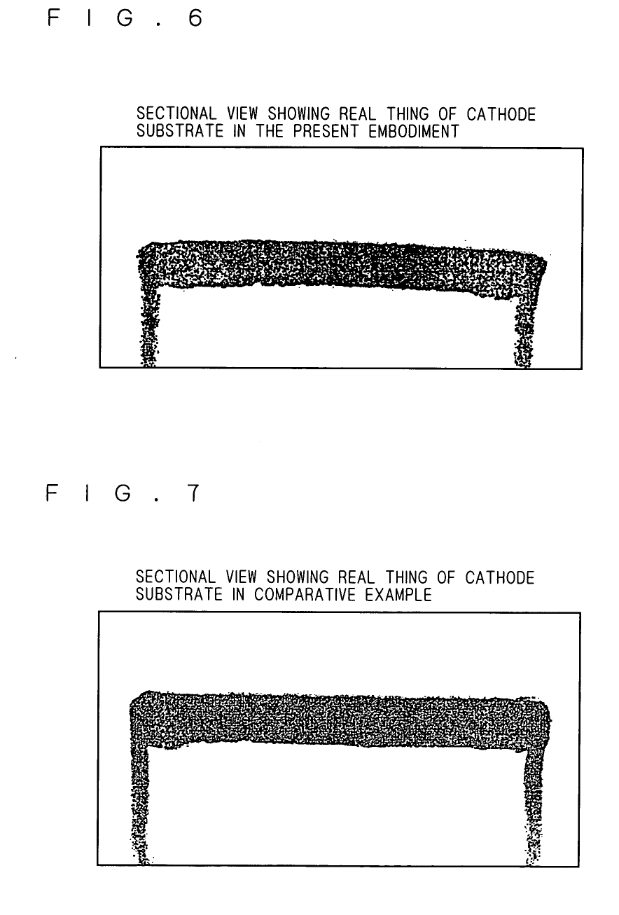

Moreover, FIG. 6 is a sectional view showing a real thing of the cathode substrate 7 in the cathode 1 for an electron tube according to the present embodiment after the test of FIG. 5 (that is, after the cathode-ray tube is operated for 10000 hours). FIG. 7 is a sectional view showing the real thing of the cathode substrate 7 in the cathode for an electron tube according to the comparative example after the test of FIG. 5 (that is, after the cathode-ray tube is operated for 10000 hours). Both of these drawings show photographs taken by burying a section of the cathode substrate in an epoxy resin and carrying out polishing. From FIG. 6, it was found that the cathode substrate 7 of the cathode 1 for an electron tube according to the present embodiment is deformed protrusively (upward in the drawing) corresponding to consumption (evaporation) and retreat of the front face 11a of the electron emissive material layer 11 (approximately 20 μm). On the other hand, it is apparent from FIG. 7 that the cathode substrate of the cathode for an electron tube according to the comparative example is rarely deformed protrusively (that is, flat).

From the results of FIGS. 5 to 7, accordingly, even if the front face of the electron emissive material layer is consumed (evaporated) and retreats in the operation of the cathode-ray tube in the cathode for an electron tube according to the comparative example, the front face of the electron emissive material layer is rarely deformed protrusively so that the distance D between the front face of the electron emissive material layer and the G1 electrode g is increased. Consequently, the cut-off voltage is increased. On the other hand, in the cathode 1 for an electron tube according to the present embodiment, the front face 11a of the electron emissive material layer 11 is consumed (evaporated) and retreats in the operation of the cathode-ray tube by the technique of the (D). Since the front face 11a of the electron emissive material layer 11 is deformed protrusively, correspondingly, the distance D between the front face 11a of the electron emissive material layer 11 and the G1 electrode g is maintained to be almost constant. Consequently, it can be concluded that the fluctuation in the cut-off voltage is reduced. From this conclusion, it is apparent that the position of the front face 11a of the electron emissive material layer 11 is maintained to be almost constant and the fluctuation in the cut-off voltage in the operation of the cathode-ray tube can be reduced as described above by the technique of the (D).

While the sand blasting method has been employed as a method for forming the concavo-convex portions on the front face 7a of the cathode substrate 7 in the present embodiment, the present embodiment is not restricted to the sand blasting method. As another method, it is also possible to form the concavo-convex portions on the front face 7a of the cathode substrate 7 by a mechanical method, for example. Moreover, it is also possible to form the concavo-convex portions on the front face 7a of the cathode substrate 7 by forming a required concavo-convex surface on a press mold to be used when punching the cathode substrate 7.

While the calcium carbonate has been used as the abrasive to be utilized in the sand blasting method in the present embodiment, it is also possible to use any material suitable for an object to increase a contact area of the cathode substrate 7 with the electron emissive material layer 11 and to optimize the formation area of the metal layer 9, and it is also possible to use various materials such as glass beads.

It is apparent that a method of reducing a fluctuation in a cut-off voltage, a method of reducing an attenuation of a fetch current and a method of manufacturing a cathode for an electron tube are also included in the scope of the present embodiment.

Japanese Patent Application Laid-Open No. 9-190761 (1997) has disclosed a technique for dividing and dispersing a metal layer into a plurality of parts to form a front face of a cathode substrate, thereby reducing a fluctuation in a cut-off voltage, that is, a technique for maintaining the distance D between the front face of the cathode substrate and the G1 electrode to be constant. In this respect, this publication is common to the present invention. In the present invention, however, the cathode substrate 7 is deformed protrusively by the expansion with the alloying of the metal layer 9 and the cathode substrate 7 and the front face 11a of the electron emissive material layer 11 is consumed and retreats. Correspondingly, the metal layer 9 is formed in such a manner that the front face 11a of the electron emissive material layer 11 is deformed protrusively. On the other hand, the publication is different from the present invention in that the metal layer is formed in such a manner that the cathode substrate is prevented from being deformed protrusively by the expansion with the alloying of the metal layer and the cathode substrate.

This difference is made due to the fact that the present invention is a technique for reducing a fluctuation in a cut-off voltage generated when consumption (evaporation) of the front face 7a of the cathode substrate 7 is remarkable and a fetch current having such a magnitude (for example, 4 A/cm²) as to cause the front face 7a of the cathode substrate 7 to retreat by the consumption is treated, the publication is a technique for reducing a fluctuation in a cut-off voltage generated when a reducing metal layer is formed between the cathode substrate and the electron emissive material layer and the consumption (evaporation) of the front face of the electron emissive material layer is not caused, and a fetch current having such a magnitude (for example, 2 A/cm²) as not to cause the retreat of the front face of the electron emissive material layer is treated, and their mechanisms for generating the fluctuation in the cut-off voltage are different from each other (that is, both of them are based on different technical ideas).

Accordingly, even if the technique of the publication is applied to the present invention, the technique of the publication cannot reduce the fluctuation in the cut-off voltage which is caused when the fetch current is large as in the present invention. In this connection, in the case in which the technique of the publication is applied to the present invention, the front face 11a of the electron emissive material layer 11 is consumed and retreats so that the front face 11a of the electron emissive material layer 11 is neither protruded nor deformed forward. Consequently, the fluctuation in the cut-off voltage is increased as in the comparative example of FIG. 5. From the foregoing, it is apparent that the publication is technically different from the present invention and the advantages of the present invention cannot be obtained from the publication.

While the present invention has been described in detail, the above description is only illustrative in all aspects and the present invention is not restricted thereto. It is understood that numerous variants which are not illustrated can be supposed without departing from the scope of the present invention.

1-24. (canceled)

25. A method of reducing a fluctuation in a cut-off voltage of a cathode for an electron tube in which a metal layer for protrusively deforming a cathode substrate when heated is formed on a surface of said cathode substrate, and an electron emissive material layer is formed on a front face of said cathode substrate directly or through said metal layer and heating means for heating said electron emissive material layer to emit a thermion from a front face of said electron emissive material layer is provided,
wherein when said front face of said electron emissive material layer is consumed and retreats, said protrusive deformation of said cathode substrate by said metal layer is induced by a heating operation of said heating means so that said front face of said electron emissive material layer is correspondingly deformed protrusively, and
wherein said metal layer is formed on concavo-convex portions provided on said surface of said cathode substrate.

26. The method of reducing a fluctuation in a cut-off voltage according to claim 25, wherein said metal layer is divided into a plurality of parts that are dispersively formed on said surface of said cathode substrate.

27. A method of reducing a fluctuation in a cut-off voltage of a cathode for an electron tube in which a metal layer for protrusively deforming a cathode substrate when heated is formed on a surface of said cathode substrate, and an electron emissive material layer is formed on a front face of said cathode substrate directly or through said metal layer and heating means for heating said electron emissive material layer to emit a thermion from a front face of said electron emissive material layer is provided,
wherein when said front face of said electron emissive material layer is consumed and retreats, said protrusive deformation of said cathode substrate by said metal layer is induced by a heating operation of said heating means so that said front face of said electron emissive material layer is correspondingly deformed protrusively, and
wherein said metal layer is formed on concavo-convex portions provided on said front face of said cathode substrate and is alloyed with a metal contained in said cathode substrate by a heating operation of said heating means and is thus expanded, thereby protrusively deforming said front face of said cathode substrate.

28. The method of reducing a fluctuation in a cut-off voltage according to claim 27, wherein said metal layer is divided into a plurality of parts that are dispersively formed on said surface of said cathode substrate.

29. A cathode for an electron tube comprising:
a cathode substrate;
a metal layer formed on a surface of said cathode substrate and heated to protrusively deform said cathode substrate;
an electron emissive material layer formed on a front face of said cathode substrate directly or through said metal layer; and
means for heating said electron emissive material layer to emit a thermion from a front face of said electron emissive material layer,
wherein when said front face of said electron emissive material layer is consumed and retreats, said protrusive deformation of said cathode substrate by said metal layer is induced by a heating operation of said means for heating so that said front face of said electron emissive material layer is correspondingly deformed protrusively, and
wherein said metal layer is formed on concavo-convex portions provided on said surface of said cathode substrate.

30. The cathode for an electron tube according to claim 29, wherein said metal layer is divided into a plurality of parts that are dispersively formed on said surface of said cathode substrate.

31. A cathode for an electron tube comprising:
a cathode substrate;
a metal layer formed on a surface of said cathode substrate and heated to protrusively deform said cathode substrate;
an electron emissive material layer formed on a front face of said cathode substrate directly or through said metal layer; and
means for heating said electron emissive material layer to emit a thermion from a front face of said electron emissive material layer,
wherein when said front face of said electron emissive material layer is consumed and retreats, said protrusive deformation of said cathode substrate by said metal layer is induced by a heating operation of said means for heating so that said front face of said electron emissive material layer is correspondingly deformed protrusively, and
wherein said metal layer is formed on concavo-convex portions provided on said front face of said cathode substrate and is alloyed with a metal contained in said cathode substrate by a heating operation of said means for heating and is thus expanded, thereby protrusively deforming said front face of said cathode substrate.

32. The cathode for an electron tube according to claim 31, wherein said metal layer is divided into a plurality of parts that are dispersively formed on said surface of said cathode substrate.
